(19) United States
(12) Patent Application Publication
(10) Pub. No.: US 2003/0117749 A1
(43) Pub. Date: Jun. 26, 2003

(54) Perpendicular read/write head for use in a disc drive storage system

(76) Inventors: Alexander M. Shukh, Savage, MN (US); Frank E. Stageberg, Edina, MN (US)

Correspondence Address: PAUL T. DIETZ, WESTMAN CHAMPLIN & KELLY, Suite 1600 - Internatiional Center, 900 South Second Avenue, Minneapolis, MN, 55402-3319, US

(21) Appl. No.: 10/027,046

(22) Filed: Dec. 20, 2001

(51) Int. Cl. G11B 5/127

(52) U.S. Cl. 360/317

(57) ABSTRACT

A read/write head for use in a disc drive storage system includes perpendicular writing and reading elements. The perpendicular writing element includes a main pole, a return pole, a write gap, and a conductive coil. The return pole is located downstream of the main pole relative to a rotating disc and is connected to the main pole at a back gap. The write gap and the conductive coil are positioned between the main and return poles. The conductive coil is adapted to induce magnetic flux in the main and return poles. The reading element can be positioned upstream or downstream of the perpendicular writing element and includes top and bottom shields and a read sensor positioned therebetween.

### FIELD OF THE INVENTION

The present invention relates generally to disc drive storage systems, and more particularly, but not by limitation, to a perpendicular read/write head for use in a disc drive storage system to read data from, and write data to, a magnetic recording medium.

### BACKGROUND OF THE INVENTION

Disc drives are the primary devices employed for mass storage of computer programs and data. Disc drives typically use rigid discs, which are coated with a magnetizable medium in which data can be stored in a plurality of circular, concentric data tracks. Typical read/write heads include separate read and write head portions. One advantage to this configuration is that the read and write heads can be optimized for the particular task they are to perform.

The read head includes a magnetoresistive or a giant magnetoresistive read element that is adapted to read magnetic flux transitions recorded to the tracks which represents the bits of data. The magnetic flux from the recording medium causes a change in the electrical resistivity of the read element, which can be detected by passing a sense current through the read element and measuring a voltage across the read element. The voltage measurement can then be decoded to determine the recorded data. The write head includes an inductive recording or write element for generating a magnetic field that aligns the magnetic moments of the recording layer to represent the desired bits of data. One advantage to this configuration is that the read and write elements can be optimized for the particular task they are to perform.

Magnetic recording techniques include both longitudinal and perpendicular recording. Perpendicular recording is a form of magnetic recording in which a principal orientation of the magnetization in the recording medium is oriented perpendicular to the medium surface, as opposed to the longitudinal principal orientation of the magnetization in the more traditional longitudinal recording technique. Perpendicular recording offers advantages over longitudinal recording, such as significantly higher areal density recording capability. The areal density is generally defined as the number of bits per unit length along a track (linear density in units of bits per inch) multiplied by the number of tracks available per unit length in the radial direction of the disc (track density in units of track per inch or TPI). Perpendicular write elements will likely be used to extend disc drive technology beyond data densities of 100 Gigabits per square inch (Gb/in²).

Several characteristics of the perpendicular write element play an important role in determining its areal density recording capability. One important characteristic, is that the write element must be capable of operating with a recording medium whose storage layer has a high coercivity. The coercivity of the storage layer relates to the magnitude of the external magnetic field that must be applied in order to change the orientation of the magnetization in the storage layer. A high coercivity leads to high thermal stability and suppresses the effects of demagnetizing fields to allow for higher areal density recordings.

Other important characteristics of the write element relate to the track width within which the write element can write bits of data and the linear density at which the write element can write bits of data along a given track. The track width of the write element is generally determined by a width of the pole tip of the writing main pole at an air-bearing surface (ABS). The linear density of a perpendicular write element is determined, in part, by the transition length that is required between adjoining bits or the number of flux reversals per millimeter of track length it is capable of recording. It is known that the transition length depends upon the length of a write gap or “gap length” between the main and return pole tips. As the gap length is decreased the linear bit density within a track is increased due to an increased write field gradient. It has been determined that the highest and most controllable write field gradient that can be achieved by the write element is located at the write gap or gap edge of the main pole.

Prior art perpendicular recording heads have writing and reading elements separated from each other by a magnetic shared pole. The shared pole serves as a top magnetic shield for the read element and as a return pole for the writing element. Magnetization transitions are recorded on the perpendicular recording medium by the main pole, which is located upstream of the return pole relative to the recording medium. The transitions are recorded by a trailing edge of the main pole rather than at the write gap or gap edge. As a result, this configuration does not utilize the optimum write field gradient and, therefore, can not achieve its full linear density recording potential.

A continuing need exists for improved read/write head designs to meet the never ending demands for higher disc drive storage capacity. More particularly, there exists a need for an advancement to perpendicular recording head designs to allow recording at the gap edge of the main pole to optimize the write field gradient that is used to record the sharp magnetic transitions.

### SUMMARY OF THE INVENTION

The present invention is directed to a perpendicular read/write head for use in a disc drive storage system having improved areal density recording capabilities. The read/write head includes perpendicular writing and reading elements. The perpendicular writing element includes a writing main pole, a return pole, a write gap, and a conductive coil. The return pole is located downstream of the main pole relative to the rotating disc and is connected to the main pole at a back gap. The write gap and the conductive coil are positioned between the main and return poles. The conductive coil is adapted to induce magnetic flux in the main and return poles. The reading element can be positioned either upstream or downstream of the writing element and includes top and bottom shields and a read sensor positioned therebetween.

These and other features and benefits would become apparent with a careful review of the following drawings and the corresponding detailed description.

### BRIEF DESCRIPTION OF THE DRAWINGS

FIG. 1 is a top view of a disc drive storage system with which embodiments of the present invention may be used.

FIG. 2 is a cross-sectional view of a read/write head in accordance with the prior art.

FIG. 3 is a simplified layered diagram of the prior art read/write head of FIG. 2 as viewed from the recording medium.

FIG. 4 is a graph illustrating the dependency of the write field gradient at both a gap edge and a trailing edge of a writing main pole as a function of the write gap length.

FIG. 5 is a cross-sectional view of a read/write head in accordance with an embodiment of the invention.

FIG. 6 is an simplified layered diagram of the read/write head of FIG. 5 as viewed from the recording medium.

FIG. 7 is a cross-sectional view of a read/write head in accordance with an embodiment of the invention.

FIG. 8 is an simplified layered diagram of the read/write head of FIG. 7 as viewed from the recording medium.

### DETAILED DESCRIPTION OF ILLUSTRATIVE EMBODIMENTS

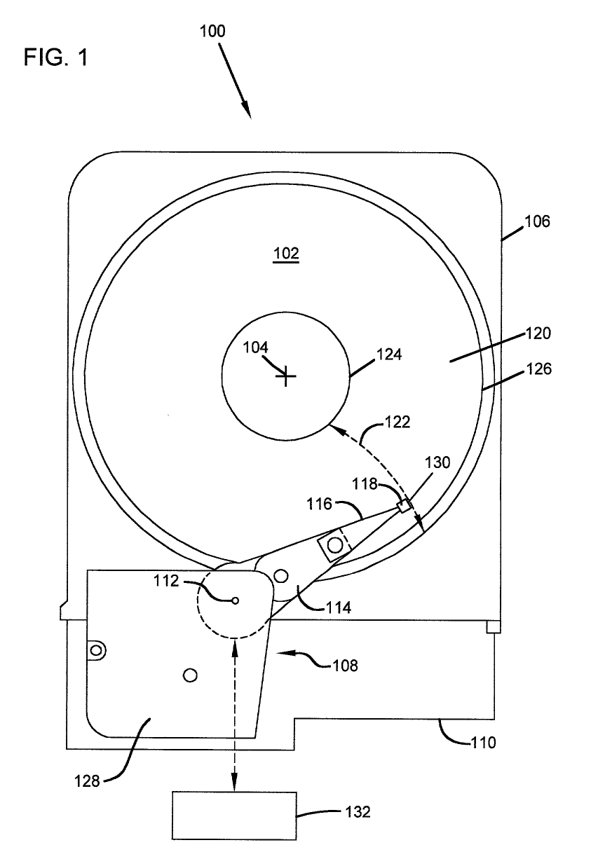

FIG. 1 is a top view of a disc drive 100, with which embodiments of the present invention may be used. Disc drive 100 includes a magnetic disc 102 mounted for rotational movement about an axis 104 and driven by a spindle motor (not shown). The components of disc drive 100 are contained within a housing that includes a base 106 and a cover (not shown). Disc drive 100 also includes an actuator 108 mounted to a base plate 110 and pivotally moveable relative to disc 104 about an axis 112. Actuator mechanism 108, includes an actuator arm 114 and a suspension assembly 116. A slider 118 is coupled to suspension assembly 116 through a gimbaled attachment which allows slider 118 to pitch and roll as it rides on an air bearing above a surface 120 of disc 102. Actuator mechanism 108 is adapted to rotate slider 118 on an arcuate path 122 between an inner diameter 124 and an outer diameter 126 of disc 102. A cover 128 can cover a portion of actuator mechanism 108. Slider 118 supports a head 130 at a trailing portion. Head 130 includes separate perpendicular reading and write elements for reading data from, and recording data to disc 102.

During operation, as disc 102 rotates, air (and/or a lubricant) is dragged under air bearing surfaces (ABS) of slider 118 in a direction approximately parallel to the tangential velocity of disc 102. As the air passes beneath the bearing surfaces, air compression along the air flow path causes the air pressure between disc surface 120 and the bearing surfaces to increase, which creates a hydrodynamic lifting force that counteracts a load force provided by suspension 116 and causes slider 118 to “fly” above, and in close proximity to, disc surface 120. This allows slider 118 to support head 130 in close proximity to the disc surface 120.

A drive controller 132 controls actuator mechanism 108 through a suitable connection. Drive controller 132 can be mounted within disc drive 100 or located outside of disc drive 100. During operation, drive controller 132 receives position information indicating a portion of disc 102 to be accessed. Drive controller 132 receives the position information from an operator, from a host computer, or from another suitable controller. Based on the position information, drive controller 132 provides a position signal to actuator mechanism 108. The position signal causes actuator mechanism 108 to pivot about axis 112. This, in turn, causes slider 118 and the head 130 it is supporting to move radially over disc surface 120 along path 122. Once head 130 is appropriately positioned, drive controller 132 then executes a desired read or write operation.

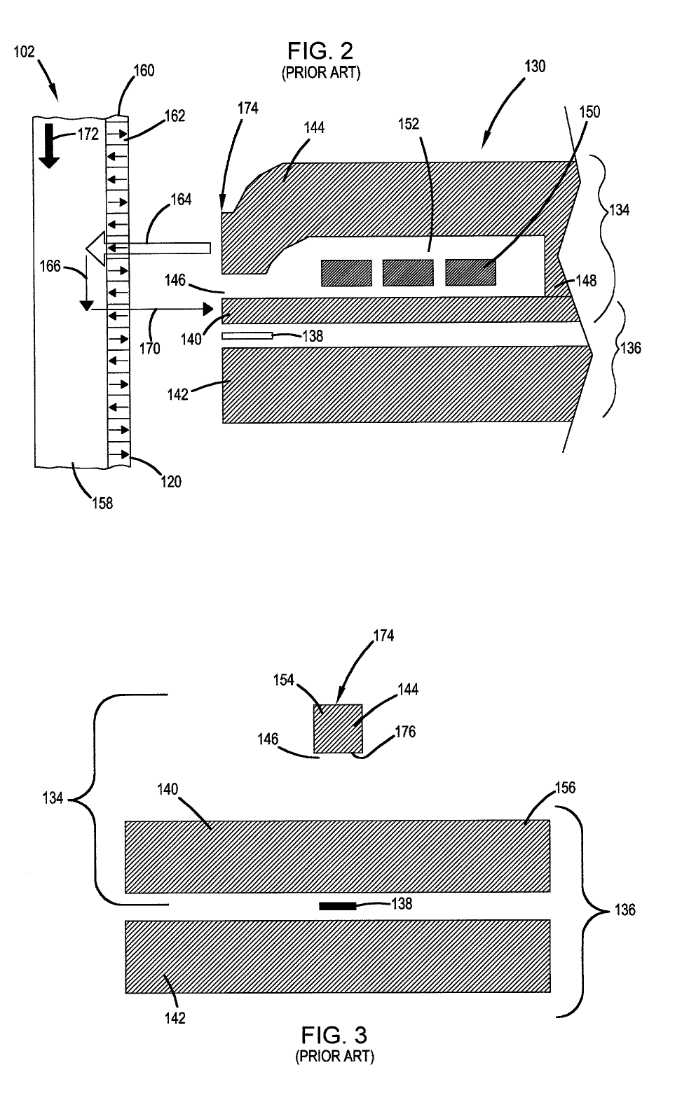

A side cross-sectional view of read/write head 130 in accordance with the prior art is shown in FIG. 2. FIG. 3 is a layered diagram of the read/write head 130 of FIG. 2 as viewed from disc 102 and illustrates the location of a plurality of significant elements as they appear along an air bearing surface of head 130. In FIG. 3, all spacing and insulating layers are omitted for clarity. Read/write head 130 includes a writing element 134 and a reading element 136. Reading element 136 of head 130 includes a read sensor 138 that is spaced between a return pole 140, which operates as a top shield, and a bottom shield 142. The top and bottom shields operate to isolate the reading element from external magnetic fields that could affect its sensing bits of data that have been recorded on disc 102.

Writing element 134 includes a writing main pole 144 and the return pole 140. The main and return poles 144 and 140 are separated by a write gap (formed by a gap layer) 146. Main pole 144 and return pole 140 are connected at a back gap “via” 148. A conductive coil 150 extends between main pole 144 and return pole 140 and around back gap 148. An insulating material 152 electrically insulates conductive coil 150 from main and return poles 144 and 140. Main and return poles 144 and 140 include main and return pole tips 154 and 156, respectively, which face disc surface 120 and form a portion of the ABS of slider 118 (FIG. 1).

A magnetic circuit is formed in writing element 134 by main and return poles 144 and 140, back gap 146, and a soft magnetic layer 158 of disc 102 which underlays a hard magnetic or storage layer 160 with perpendicular orientation of magnetization. Storage layer 160 includes uniformly magnetized regions 162, each of which represent a bit of data in accordance with their up or down orientation. In operation, an electrical current is caused to flow in conductor coil 150, which induces a magnetic flux that is conducted through the magnetic circuit. The magnetic circuit causes the magnetic flux to travel vertically through the main pole tip 154 and storage layer 160 of the recording medium, as indicated by arrow 164. Next, the magnetic flux is directed horizontally through soft magnetic layer 158 of the recording medium, as indicated by arrow 166, then vertically back through storage layer 160 through return pole tip 156 of return pole 140, as indicated by arrow 170. Finally, the magnetic flux is conducted back to main pole 144 through back gap 148.

Main pole tip 154 is shaped to concentrate the magnetic flux traveling therethrough to such an extent that the orientation of magnetization in patterns 162 of storage layer 160 are forced into alignment with the writing magnetic field and, thus, cause bits of data to be recorded therein. In general, the magnetic field in storage layer 160 at main pole tip 154 must be twice the coercivity or saturation field of that layer. Head 130 travels in the direction indicated by arrow 172 (FIG. 3) relative to disc 102 thereby positioning main pole 144 downstream of return pole 140 relative to disc 102. As a result, a trailing edge 174 of main pole 144 operates as a “writing edge” that defines the transitions between bits of data recorded in recording layer 160, since the field generated at that edge is the last to define the magnetization orientation in the pattern 162.

The linear density of recorded bits of data depends on the transition length between adjoining bits. As the transition length is decreased, there is an increase in the linear density. The transition length depends on the write field gradient in the recording layer, which depends on the length of the write gap 146 or “gap length” between the main and return pole tips 154 and 156. As the gap length is decreased the write field gradient and the linear bit density recording capability of the writing element is increased. Techniques have been developed to reduce the gap length to substantially less than one micrometer to realize higher linear recording densities. Unfortunately, there are limitations as to the benefits that can be realized from shrinking the gap length. In particular, the amount that the gap length can be reduced is limited due to shunting of magnetic flux across the write gap, which results in a decrease in the write field strength in the storage layer 160. This effect limits the coercivity of the recording medium on which the writing element can record data and, thus, the areal density recording capability of the writing element.

One aspect of the present invention is the result of a realization that the write field gradient and magnitude of the magnetic field at the trailing or writing edge of the main pole tip, plays a significant role in the areal density recording capability of the writing element. In particular, the magnitude of the write field at the main pole tip determines the coercivity of the recording media with which the writing element can operate for a given gap length. Additionally, it has been determined that a higher write field gradient at the writing edge allows for shorter transition lengths between adjoining bites. Accordingly, the write field gradient at the writing edge plays a significant role in determining the areal density recording capability of the writing element. Unfortunately, writing elements of the prior art, such as that depicted in FIGS. 2 and 3, fail to use the edge of the writing main pole having the highest and most controllable write field gradient.

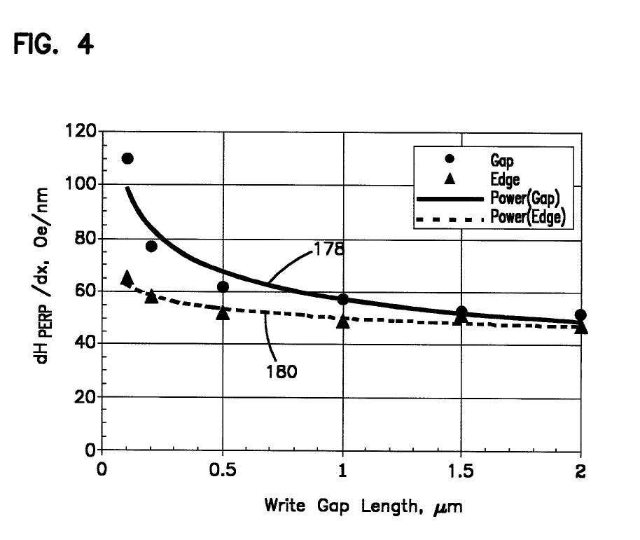

For example, trailing edge 174 of main pole tip 154 of writing element 134 operates as the writing edge, as mentioned above. However, it has been discovered that the write field gradient is higher at a leading gap edge 176 of the writing main pole tip 154 than at trailing edge 174. This characteristic is illustrated in the graph of FIG. 4, which shows the dependency of the write field gradient at both gap edge 176 (line 178) and trailing or writing edge 174 (line 180) of main pole tip 154 as a function of the write gap length 146. As evidenced by the graph, the decrease in the write gap length causes the write field gradients at gap and writing edges 176 and 174 to diverge substantially with the write field gradient at gap edge 176 being significantly higher than that at writing edge 174 at gap lengths of approximately less than one micrometer. As a result, although the gap lengths of writing elements 134 of the prior art may be formed extremely small, the resulting write element cannot achieve its full linear density recording potential due to the low write field gradient at the writing edge 176.

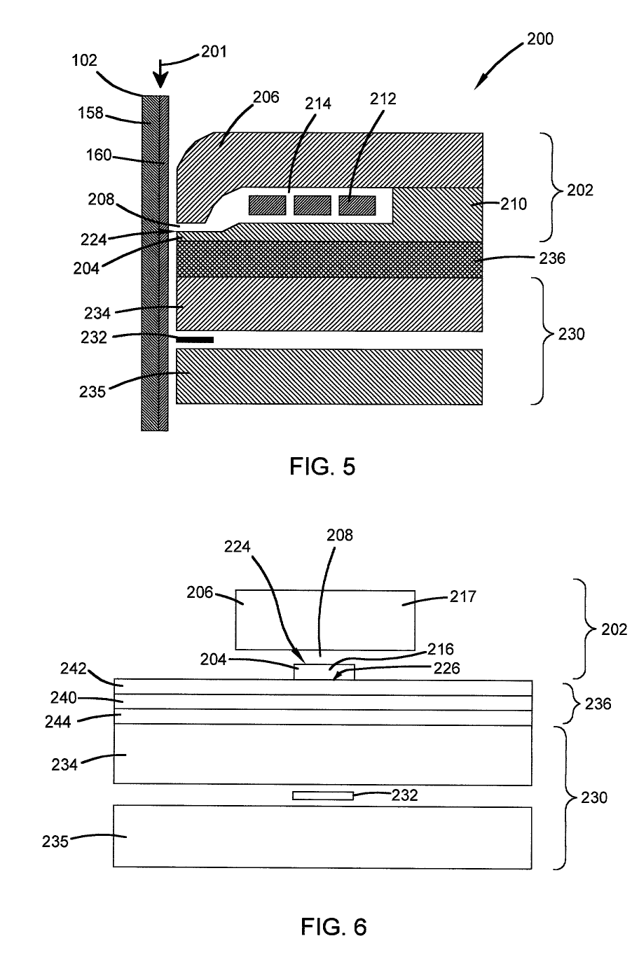

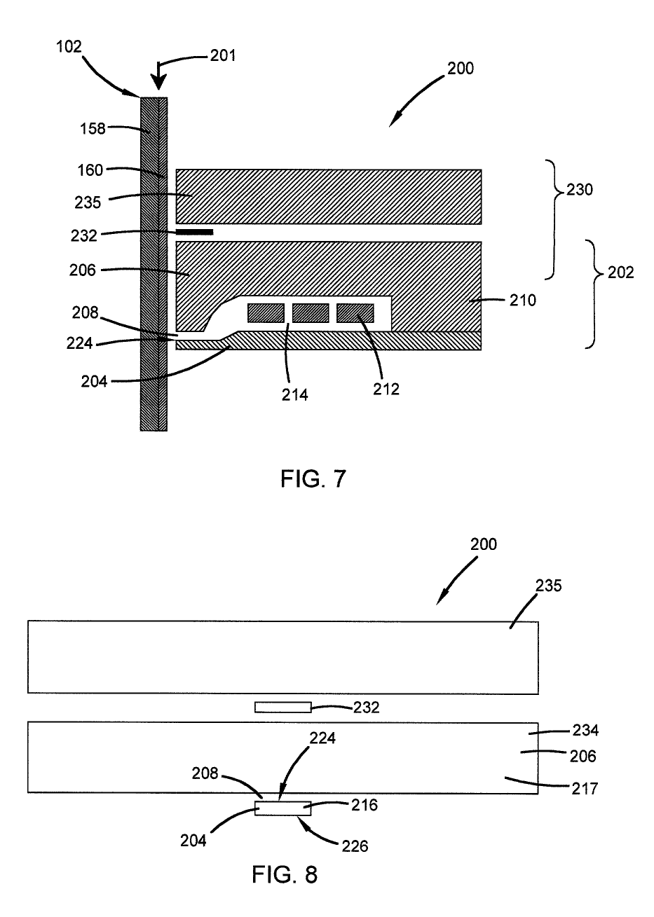

The areal density recording capabilities of the writing elements of the present invention are improved over those of the prior art by locating the writing edge of the main writing pole in the write gap, as will be discussed with reference to FIGS. 5-8. This results in a higher write field gradient at the writing edge, which allows the writing element to be used with recording media having a high coercivity and record data at a high linear density. FIGS. 5 and 6 respectively show a side cross-sectional view and a simplified layered diagram of a read/write head 200 in accordance with one embodiment of the invention, while FIGS. 7 and 8 respectively show a side cross-sectional view and a simplified layered diagram of a read/write head 200 in accordance with another embodiment of the invention.

Read/write head 200 travels in the direction indicated by arrow 201 relative to disc 102 and includes write element 202 having a writing or main pole 204, a return pole 206, a write gap 208 separating main pole 204 and return pole 206, a back gap 210 where write and return poles 204 and 206 are connected, and a conductive coil 212. These components are formed using conventional thin film processing techniques. Writing and return poles 204 and 206 are formed of a magnetic material with high permeability and low coercivity such as cobalt-iron (CoFe), cobalt-nickel-iron (CoNiFe), nickel-iron (NiFe), iron nitride (FeN), or other suitable magnetic material. In accordance with one embodiment of the invention, main pole 204 is formed of a soft magnetic material having a high magnetic flux density (above 1.0 T) such as CoFe, CoNiFe, Ni₄₅Fe₅₅, FeN, FeAlN, or other suitable material. Conductive coil 212 is positioned between writing pole 204 and return pole 206 and around back gap 210. An insulating material 214 electrically insulates conductive coil 212 from writing and return poles 204 and 206. Writing pole 204, return pole 206 and write gap 208 include writing and return pole tips 216 and 217 (FIGS. 6 and 8) that face disc 102 and form a portion of the air bearing surface at a trailing edge of the slider 118 (FIG. 1) carrying head 200. Writing and return pole tips 216 and 217 are separated by the write gap 208 having a length that is preferably less than one micrometer.

Writing pole tip 216 has a disc-facing surface that has a small cross-sectional area to concentrate the magnetic flux directed therethrough such that the magnetic write field exceeds the saturation field of the recording layer 160 to allow data to be recorded to disc 102 in substantially the manner discussed above. The disc facing surface of return pole tip 217 has an area that is many times greater than that of writing pole tip 216 to reduce the magnetic field in the adjacent storage layer 160 to less than a nucleation field of the storage layer 160. This is necessary since writing main pole 204 is positioned upstream of return pole 206 relative to disc 102. Because the strength of the magnetic write field in the storage layer 160 at the return pole tip 217 is lower than the nucleation field of the storage layer 160, there is very little effect by way of weakening the magnetization in any patterns 162 in the recording medium that have been recorded by the upstream writing main pole 204.

Writing pole tip 220 includes a trailing edge 224 and a leading edge 226. Trailing edge 224 is located in the write gap 208 and operates as the writing edge, which forms the transition between adjoining patterns 162 (FIG. 2) as discussed above. The location of writing edge 224 improves upon writing elements of the prior art due to the significantly higher write field gradient at that location than at leading edge 226. The linear density of data that can be recorded using write element 202 of the present invention is, therefore, higher than that of write elements of the prior art. Accordingly, writing element 202 can achieve higher areal density recordings than writing elements of the prior art.

Head 200 also includes a reading element 230 having a read sensor 232 for reading the data recorded in storage layer 160. Read sensor 232 is preferably a conventional read sensor that operates in accordance with magnetoresistive or giant magnetoresistive principles. In accordance with one embodiment of the invention, reading element 230 is positioned downstream of writing element 202, as shown in FIGS. 5 and 6. Unlike prior art writing elements, the reduced size of the adjacent writing pole 204 cannot be used as a shield for read sensor 232 at the pole tip region. Instead, separate top and bottom shields 234 and 235 are used to shield sensor 232 from external magnetic fields. Top shield 234 is separated from top main pole 204 by an non-magnetic layer 236.

Non-magnetic layer 236 has a sufficient thickness, preferably 1-5 micrometers, to prevent shunting of lines of magnetic flux through top shield 234 which could adversely affect the operation of writing element 202. In accordance with one embodiment, non-magnetic layer 236 is formed of a aluminum oxide (Al₂O₃), silicon oxide (SiO₂), silicon nitride (Si₃N₄), tantalum oxide (Ta₂O₅), or other suitable non-magnetic material, as shown in FIG. 5. Alternatively, non-magnetic layer 236 can be formed of a multi-layer material having a conductive layer 240 sandwiched between insulating layers 242 and 244, as shown in FIG. 6. The conductive layer 240 could be formed of copper (Cu), aluminum (Al), tantalum (Ta), tungsten (W), or other suitable conductive material. The insulating layers can be formed of an aluminum oxide (Al₂O₃), silicon nitride (Si₃N₄), silicon oxide (SiO₂), tantalum oxide (Ta₂O₅),or other suitable insulating material.

In accordance with another embodiment of the invention, reading element 230 is positioned upstream of writing element 202, as shown in FIGS. 7 and 8. This arrangement allows return pole 206 to operate as a bottom shield 235 for reading element 230. As a result, this embodiment of the invention eliminates the need for non-magnetic layer 236 and a separate bottom shield, which results in a more compact read/write head 200, process simplicity and yield increase. A further advantage to this embodiment of the invention is that the read sensor 232 can be positioned closer to disc surface 120. This is the result of being positioned closer to the trailing edge of the slider 118 (FIG. 1), which is lower than the leading edge of the slider during normal operation. This configuration is particularly advantageous for perpendicular recordings as compared to longitudinal recordings, because the fringing field generated by patterns with perpendicular magnetization 162 (FIG. 2) decays faster with the distance than the fringing field of longitudinal medium. It is therefore, desirable to position read sensor 232 as close to recording layer 160 as possible so that the small patterns with low fringing field can be accurately detected. Furthermore, the lower position of read sensor 232 allows for higher reading resolution thereby allowing read/write head 200 to operate with higher areal density recordings.

In summary, the present invention is directed to a perpendicular read/write head (such as 200) for use in a disc drive storage system (such as 100) to record data (such as 162) to, and read data from, a magnetic storage layer (such as 160) of a rotating disc (such as 102). The read/write head generally includes a perpendicular writing element (such as 202) and a perpendicular reading element (such as 230). The perpendicular writing element includes a writing main pole (such as 204), a return pole (such as 206) that is connected to the recording pole at a back gap (such as 210), a gap layer or write gap (such as 208) between the recording and return poles, and a conductive coil (such as 212). The return pole is located downstream of the main pole relative to the rotating disc. The conductive coil is positioned between the main and return poles and is adapted to induce magnetic flux therein. In accordance with another embodiment of the invention, the write gap is preferably approximately 1 micrometer or less.

In accordance with one embodiment of the invention, the perpendicular reading element is positioned upstream of the perpendicular writing element relative to the rotating disc and includes a top shield (such as 234), a bottom shield (such as 235), upstream of the top shield, and a read sensor (such as 232) positioned between the top and bottom shields. An non-magnetic layer (such as 236) separates the top shield from the recording pole. The non-magnetic layer can be formed of a non-magnetic dielectric material or a multi-layered non-magnetic material including a conductive layer (such as 240) sandwiched between insulating layers (such as 242 and 244). The thickness of the non-magnetic layer is greater than one micrometer and preferably less than five micrometers.

In accordance with another embodiment of the read/write head of the present invention, the perpendicular reading element is positioned downstream of the perpendicular writing element. In this embodiment, the perpendicular reading element includes a top shield (such as 235) and a read sensor (such as 232) positioned between the top shield and the return pole (such as 206), which operates as a bottom shield for the read sensor.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

What is claimed is:

1. A perpendicular read/write head for use in a disc drive storage system to record data to, and read data from, a magnetic medium of a rotating disc, the head comprising:
a perpendicular writing element including a main pole, a return pole located downstream of the main pole relative to the rotating disc and connected to the main pole at a back gap, a write gap between the main and return poles, and a conductive coil between the main and return poles and adapted to induce magnetic flux therein;
a perpendicular reading element upstream of the perpendicular writing element and including a top shield, a bottom shield upstream of the top shield, and a read sensor positioned between the top and bottom shields; and
a non-magnetic layer separating the top shield from the writing main pole.

2. The head of claim 1, wherein the main and return poles are formed of a magnetically permeable material selected from a group consisting of CoZr, CoZrNb, Ni₄₅Fe₅₅, FeN, FeAlN, cobalt-iron (CoFe), cobalt-nickel-iron (CoNiFe), nickel-iron (NiFe), and iron (Fe).

3. The head of claim 1, wherein the non-magnetic layer is formed of a non-magnetic insulating material.

4. The head of claim 3, wherein the non-magnetic layer is formed of silicon oxide (SiO₂), silicon nitride (Si₃N₄), aluminum oxide (Al₂O₃), or tantalum oxide (Ta₂O₅)

5. The head of claim 1, wherein the non-magnetic layer is formed of a conductive layer sandwiched between insulating layers.

6. The head of claim 5, wherein the conductive layer is copper (Cu), aluminum (Al), tantalum (Ta), or tungsten (W), and the insulating layers are aluminum oxide (Al₂O₃), silicon oxide (SiO₂), tantalum oxide (Ta₂O₅) or silicon nitride (Si₃N₄).

7. The head of claim 1, wherein a thickness of the non-magnetic layer is approximately 1 micrometer or greater.

8. The head of claim 1, wherein the gap layer defines a write gap of approximately 1 micrometer or less.

9. A disc drive storage system including the read/write head of claim 1.

10. A perpendicular read/write head for use in a disc drive storage system to record data to, and read data from, a magnetic medium of a rotating disc, the head comprising:
a perpendicular writing element including a main pole, a return pole located downstream of the main pole relative to the rotating disc and connected to the main pole at a back gap, a write gap between the main and return poles, and a conductive coil between the main and return poles and adapted to induce magnetic flux therein; and
a perpendicular reading element downstream of the perpendicular writing element and including a top shield, and a read sensor positioned between the top shield and the return pole, wherein the wherein the return pole serves as a bottom shield for the read sensor.

11. The head of claim 10, wherein the main and return poles are formed of a magnetically permeable material selected from a group consisting of CoZr, CoCzNb, Ni₄₅Fe₅₅, FeN, FeAlN, cobalt-iron (CoFe), cobalt-nickel-iron (CoNiFe), nickel-iron (NiFe), and iron (Fe).

12. The head of claim 10, wherein the write gap is approximately 1 micrometer or less.

13. A disc drive storage system including the head of claim 10.

14. A disc drive storage system, comprising:
a rotating disc having a recording medium; and
a read/write head means for performing perpendicular recording and reading of magnetic signals in the recording medium at a high areal density.

15. The system of claim 14, wherein the read/write head means includes:
a perpendicular writing element including a main pole, a return pole located downstream of the main pole relative to the rotating disc and connected to the main pole at a back gap, a write gap between the main and return poles, and a conductive coil between the main and return poles adapted to induce magnetic flux therein;
a perpendicular reading element upstream of the perpendicular writing element and including a top shield, a bottom shield upstream of the top, and a read sensor positioned between the top and bottom shields; and
a non-magnetic layer separating the top shield from the main pole.

16. The head of claim 15, wherein a thickness of the non-magnetic layer is approximately 1 micrometer or greater.

17. The head of claim 15, wherein the non-magnetic layer is formed of a conductive layer sandwiched between insulating layers.

18. The head of claim 17, wherein the conductive layer is copper (Cu), aluminum (Al), tantalum (Ta), or tungsten (W), and the insulating layers are aluminum oxide (Al₂O₃), silicon oxide (SiO₂), tantalum oxide (Ta₂O₅) or silicon nitride (Si₃N₄).

19. The system of claim 14, wherein the read/write head means includes:
a perpendicular writing element including a main pole, a return pole located downstream of the main pole relative to the rotating disc and connected to the main pole at a back gap, a write gap between the main and return poles, and a conductive coil between the main and return poles and adapted to induce magnetic flux therein; and
a perpendicular reading element downstream of the perpendicular writing element and including a top shield, and a read sensor positioned between the top shield and the return pole, wherein the wherein the return pole serves as a bottom shield for the read sensor.
